(19) United States
(12) Patent Application Publication
(10) Pub. No.: US 2009/0109659 A1
(43) Pub. Date: Apr. 30, 2009

(54) Footwear with integrated power system

(75) Inventor: Kerry S. Harris, San Antonio, TX (US)

Correspondence Address: KERRY HARRIS;IHT TECHNOLOGY, INC., 7715 MAINLAND ROAD, SUITE 115, SAN ANTONIO, TX, 78250, US

(73) Assignee: IHT Technology, Inc., San Antonio, TX (US)

(21) Appl. No.: 11/980,966

(22) Filed: Oct. 30, 2007

(51) Int. Cl. F21V 21/08; F21L 4/08

(52) U.S. Cl. 362/103; 362/183

(57) ABSTRACT

Techniques for footwear with integrated power systems are described, including a port configured to receive an electrical current, a power cell configured to store the electrical current from the port, a light source coupled to the power cell, a switch configured to control activation of the light source, the switch being coupled to the light source and the power cell, and a distribution system configured to provide a path to enable the electrical current to flow within the system.

### CROSS REFERENCE TO RELATED APPLICATIONS

This application is related to co-pending U.S. patent application Ser. No. 11/040,974 (Attorney Docket No. ACS-001), filed Jan. 21, 2005 entitled “Electrical Power System for Crash Helmets,” U.S. patent application Ser. No. 11/527,788 (Attorney Docket No. ACS-01CIP1), filed Sep. 26, 2006 entitled “Electrical Power System for Crash Helmets,” U.S. patent application Ser. No. 11/974,500 (Attorney Docket No. ACS-001CON1), filed Oct. 11, 2007 entitled “Electrical Power System for Crash Helmets,” U.S. patent application Ser. No. 11/973,723 (Attorney Docket No. ACS-003), filed Oct. 9, 2007 entitled “Hydration Pack with Integrated Power System,” and U.S. patent application Ser. No. 11/______ (Attorney Docket No. IHT-001CIP2), filed Oct. 30, 2007 entitled “Electrical Power System for Crash Helmets,” all of which are incorporated herein by reference for all purposes.

### FIELD OF THE INVENTION

The present invention relates generally to clothing and safety equipment. Specifically, footwear with an integrated power system is described.

### BACKGROUND OF THE INVENTION

Physical activity in dark, outdoor environments can endanger personal safety, particularly when safety gear is not worn. As people engage in physical activities such as walking, jogging, running, cycling, skateboarding, or other types of similar physically exertive activities during the early or late hours of a day, the danger to their physical safety increases due to automobile traffic, location, ambient (e.g., street) lighting, and other diminished environmental conditions. There are other situations when people travel by foot as a means of transportation where minimal lighting is encountered. These outdoor environments may include walking or running paths that are commonly in the vicinity of motorists. Traveling by foot near motorists in minimally lighted surroundings poses a danger to a pedestrian. Conventional safety gear worn by pedestrians in darkened environment conditions typically use reflective material that are worn outside of normal clothing items. However, conventional safety gear is often limited and problematic.

In some conventional solutions, footwear such as shoes in the marketplace is designed to be aesthetic and stylistic, but typically lack adequate safety features. When a person travels on foot in the vicinity of motorists, there is typically a risk of injury to the pedestrian. While conventional footwear (i.e., walking, jogging, running, trail, water, or other types of shoes) is typically designed for comfort and style, features that increase the safety of a pedestrian are noticeably absent. For example, shoes may have external reflective tape or materials or incandescent light sources that reflect light shining from a motorist's headlights. However, a motorist approaching a pedestrian at different angles may encounter little or no reflections. Further, conventional reflective solutions often are limited in the distance by which a reflection is seen. In other words, a motorist traveling at an increased rate of speed may not see a person wearing conventional footwear until reaching a very close proximity, which limits the time and ability of a motorist to react to or avoid the pedestrian. Further, wear and tear of conventional footwear often results in the degradation of the reflective materials or light sources over time, thus minimizing its effectiveness. Still further, conventional solutions that rely upon the use of power sources are often weak or limited in their arcs of visibility, require heavy external power sources that are undesirably for joggers, runners, and are easily damaged due to external placement on a shoe.

Thus, what is needed is a solution for footwear with a durable powered safety feature without the limitations of conventional techniques.

### BRIEF DESCRIPTION OF THE DRAWINGS

Various embodiments of the invention are disclosed in the following detailed description and the accompanying drawings:

FIG. 1 illustrates exemplary footwear with an integrated electrical power system;

FIG. 2 is a rear perspective of exemplary footwear with an integrated electrical power system;

FIG. 3 is a bottom perspective of exemplary footwear with an integrated power system;

FIG. 4 illustrates alternative exemplary footwear with an integrated power system;

FIG. 5 illustrates an alternative rear perspective of footwear with an integrated power system; and

FIG. 6 is a circuit diagram illustrating an exemplary electrical power system circuit.

### DETAILED DESCRIPTION OF THE PREFERRED EMBODIMENTS

Implementation of described techniques may occur in numerous ways, including as a system, device, apparatus, process, a computer readable medium such as a computer readable storage medium, or a computer network wherein program instructions are sent over optical or electronic communication links.

A detailed description of one or more embodiments is provided below along with accompanying figures that illustrate the principles of the embodiments. The scope of the embodiments is limited only by the claims and encompasses numerous alternatives, modifications and equivalents. Numerous specific details are set forth in the following description. These details are provided solely for the purposes of example and the embodiments may be practiced according to the claims without some or all of these specific details.

Techniques for footwear with an integrated power system are described. Various devices, components, and systems using electrical power may be implemented. In keeping with various embodiments described herein, electrical power may be supplied from a power cell or battery (“power cell”) to different devices, systems, or components integrated with footwear. In some examples, light emitting diodes (LEDs) may be powered using electrical current from a power cell housed within a lining of a shoe. As another example, a power cell may be used to provide electrical current to a communications system. These devices, systems, or components may be manually or automatically activated using a switch coupled to the power cell using various electrical leads, wires, connectors, or membranes. By implementing the described techniques, footwear with electrical power systems may be used to provide features and functions such as those described herein.

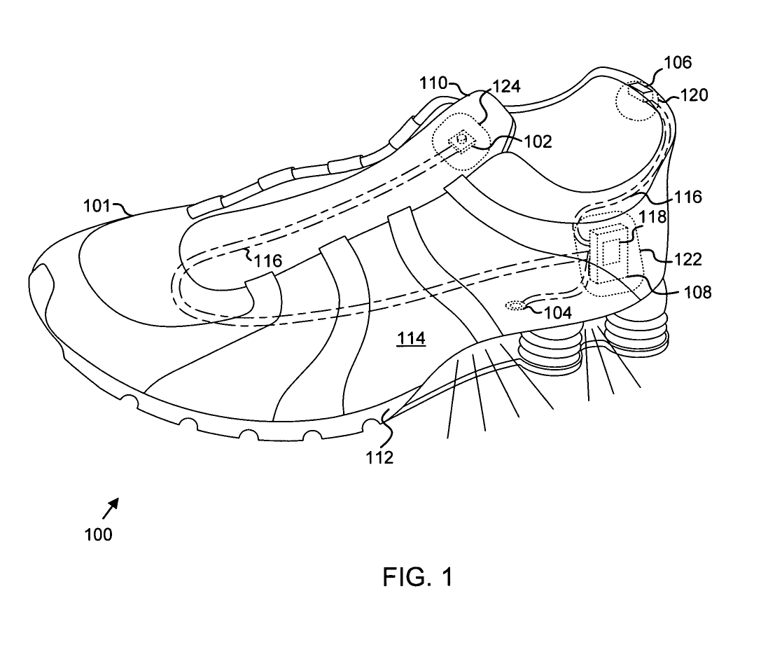

FIG. 1 illustrates exemplary footwear with an integrated electrical power system. Here, system 100 includes shoe 101, switch 102, light source 104, recharge port (i.e., connector) 106, power cell 108, tongue 110, sole 112, upper 114, electrical leads 116, processor 118, port cavity 120, battery cavity 122, and switch cavity 124. Here, shoe 101 may be implemented using footwear articles such as athletic shoes, walking shoes, work shoes, and others. In some examples, system 100 may be configured to be weather resistant to provide extra protection and durability due to inclement weather. In various examples, system 100 may be used when the footwear article (e.g., a shoe) is worn or not worn by a user.

In some examples, switch 102 may be implemented to be partially or fully exposed on tongue 110. In other examples, switch 102 may be concealed from plain view by being embedded beneath a subset of layered material (e.g., polypropylene, and other lining materials) in tongue 110. For example, the subset of layers may be non-conductive insulation material used to form the lining of shoe 101. In addition, switch 102 may be sealed within switch cavity 124, which is formed within the lining of tongue 110. As used herein, the term “cavity” refers generally to a hollow pocket, housing, aperture, or other opening formed or made within the lining of shoe 101. Switch 102 may be activated (i.e., turned on) by applying pressure. In still other examples, there may be indication on the surface of tongue 110 including labeling to identify the location of switch 102 (i.e., if switch 102 is sealed from plain view). As used herein, switch 102 may be implemented using a push-button, contact, pressure, electromechanical, mechanical, or other type of switch. In other examples, switch 102 may be implemented using other mechanisms, apparatus, or components to open or close an electrical circuit, such as those described herein.

In some examples, light source 104 may be activated or deactivated by closing or opening, respectively, switch 102. Light source 104 may be implemented using a LED having attributes or properties such as wide-angle radiation and super-flux illumination. Light source 104 may be implemented using a variation of colors, for example, blue being a color to provide a highly-intensive glow. In other examples, light source 104 may be configured to illuminate other colors such as red, white, and others. In still other examples, light source 104 may be surface mounted within open sole 112, in which open sole 112 includes holes or gaps providing transparent illumination. In another example, light source 104 may be placed within another cavity (not shown) formed in the sole of shoe 101. In some examples, a mounting surface may be disposed parallel or substantially parallel to a ground plane, and directing light from light source 104 perpendicular or substantially perpendicular to the ground plane. In still other examples, light source 104 may illuminate from the sole of shoe 101. As used herein, the term “ground plane” may refer to being a “ground surface” or “floor surface.” In addition, sole 112 may be formed using material such as non-opaque plastic to cover the cavities thereby providing substantial illumination in multiple perspectives. In some examples, there may be fewer or more implementations of light source 104 implemented in system 100.

In some examples, power cell 108 may be disposed within upper 114 beneath at least one layer of insulation (e.g., lining of shoe). In some examples, power cell 108 may be placed within battery cavity 122 formed in upper section 114 within the lining of the shoe. Battery cavity 122, in some examples, may be conductively coupled to recharge port 106. In other examples, power cell 108 may be conductively coupled to recharge port 106 by using electrical leads 116. In still other examples, multiple cavities (not shown) may be formed within a lining of shoe 101 to house one or more power cells (e.g., power cell 108), whereby each of the cavities may be conductively coupled and disposed or otherwise positioned within system 100 adjacent to each other. In some examples, recharge port 106 may be disposed on the back section of upper 114 with surface access to provide a direct or indirect connection to an external power source (e.g., DC or AC power supply, power inverter, charger, power outlet, and others). In other examples, recharge port 106 may be housed in port cavity 120 and placed near an edge of upper 114. In addition, port cavity 120 may be conductively coupled to battery cavity 122 by using electrical leads 116 or a conductive membrane (not shown) within the lining of shoe 101. As used herein, the term “port” refers generally, at least in one embodiment, to as being a “connector” or a “coupler.” In other examples, recharge port 106 may provide multiple charges by disconnecting and reconnecting to power cell 108 when needing to recharge power cell 108 to its original state. For example, the elapsed time between recharging states may be approximately 30 hours of usage time. In some examples, power cell 108 may have a processor (e.g., processor 118) implemented to control bidirectional flow of electrical current to or from power cell 108. For example, processor 118 may be programmed with instructions or commands to handle recharging or discharging over time. In still other examples, processor 118 may be formed within or integrated with power cell 108 to minimize surface area occupied at its placed location (e.g., battery cavity 122). Interconnection within system 100 may be implemented using conductive material (e.g., wires, leads, membranes, and others) extending throughout the shoe. In some examples, electrical leads 116 may be disposed in a channel (not shown) provided within the lining the shoe. In other examples, a channel may be provided that runs between one or more cavities, housings, or pockets (e.g., port cavity 120, battery cavity 122, switch cavity 124) in system 100. Further, circuit 100 and the above-described elements may be implemented differently in design, operation, configuration, and materials, and are not limited to the descriptions provided herein.

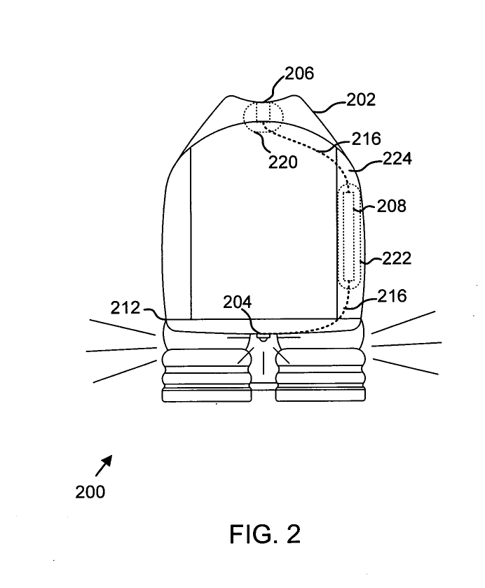

FIG. 2 is a rear perspective of exemplary footwear with an integrated electrical power system. Here, system 200 includes shoe 202, light source 204, power port 206, battery 208, sole 212, leads 216, port cavity 220, battery cavity 222, and lining 224. In some examples, battery cavity 222 may be formed within lining 224 of shoe 202, and conductively coupled to port cavity 220 and a switch cavity (not shown) using leads 216. In other examples, cavities (e.g., port cavity 220, battery cavity 222) may be integrated with lining 224 to house systems or components (e.g., light source 204, power port 206, battery 208, and others). In some examples, battery cavity 222 is sealed from plain view thus providing a low-profile and lightweight implementation in shoe 202. As used herein, the term “low-profile” may refer to a degree of low exposure. In other examples, light source 204 may be integrated with sole 212 by directing downward, and providing illumination substantially perpendicular to the mounting position. In still other examples, light source 204 may be mounted at a different position within another cavity (not shown) formed in sole 212. Different configurations may be implemented by modifying some or all of the shoe elements shown and described above.

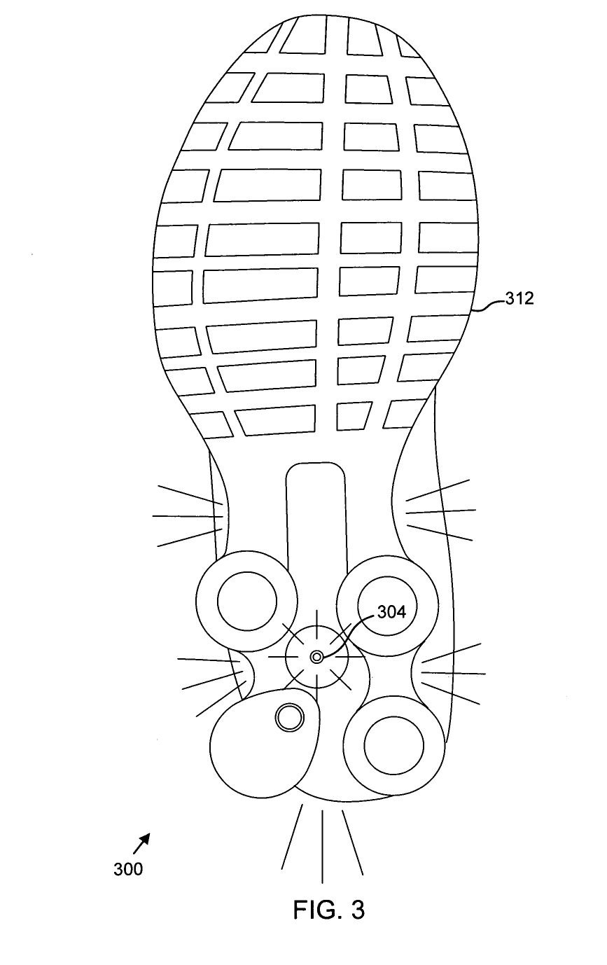

FIG. 3 is a bottom perspective of exemplary footwear with an integrated power system. Here, system 300 includes light source 304 and sole 312, which may be part of, for example, shoe 101 (FIG. 1). In some examples, system 300 may have light source 304 mounted on the bottom surface of sole 312, which may be near or substantially near the heel of sole 312. In other examples, light source 304 may be implemented in other sections of sole 312. In some example, sole 312 may be implemented with pockets, gaps, or chambers configured to house light source 304 to provide wide-angle illumination from, for example, a LED or other illumination source such as those described herein. In other examples, sole 312 may be implemented with enclosed cavities using transparent material allowing light to travel from enclosed cavities.

In some examples, light source 304 may be a blue or other colored LED. In other examples, the blue light-emitting diode may be an ultra-flux radiating source. Also, there may be more or fewer implementations of light source 304 integrated with sole 312. In other words, one or more LEDs or other light sources may be used in place of light source 304. Further, system 300 and the above-described elements may be varied and are not limited to the functions, structures, configurations, or implementations provided.

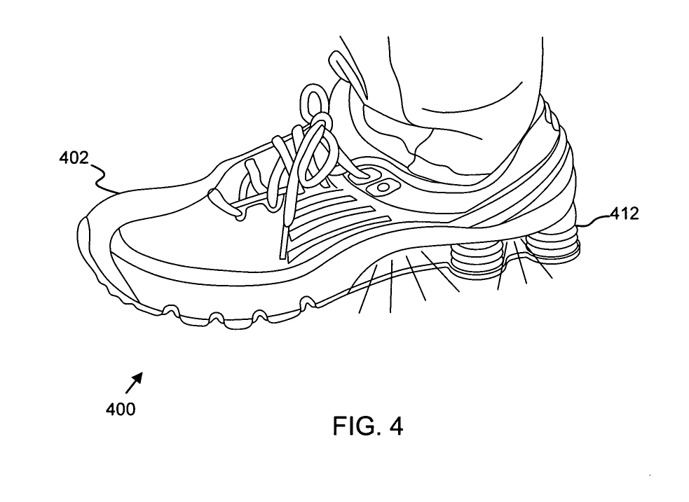

FIG. 4 illustrates alternative exemplary footwear with an integrated power system. Here, system 400 includes shoe 402 and sole 412. In some examples, system 400 may be implemented as described above in connection with system 100. In various examples, system 400 may be used by activating a light source (not shown) using integrated switch (e.g., switch 102 of FIG. 1). In some examples, illumination from a light source may project through apertures (e.g., gaps) formed in sole 412. For example, sole 412 may have apertures substantially parallel or perpendicular to the surface of sole 412. In other examples, sole 412 may be configured to provide illumination from the light source through transparent cavities (not shown) formed in sole 412. Here, system 400 may be configured to have the integrated power system sealed from plain view, for example, by being disposed within a lining of shoe 402. In other examples, system 400 and the above-described elements may be varied and are not limited to the functions, structures, configurations, or implementations provided.

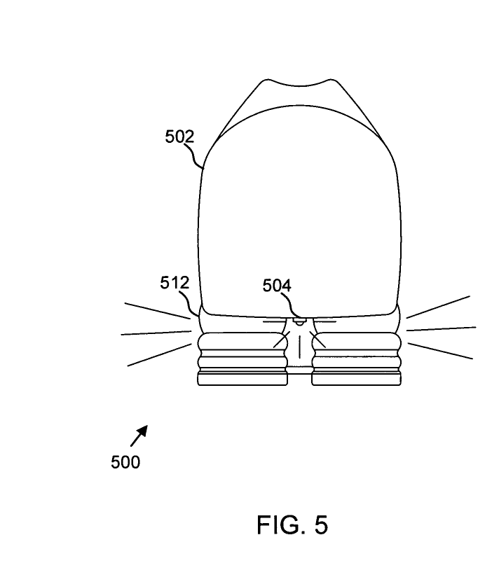

FIG. 5 illustrates an alternative rear perspective of footwear with an integrated power system. Here, system 500 includes sole 502, light source 504, and upper 506. System 500 may be implemented as described above in connection with system 200 of FIG. 2. In various examples, light source 504 may be mounted, housed, fastened, embedded, attached, coupled, or otherwise integrated (“integrated”) with sole 512. In some examples, light source 504 may be conductively coupled to other systems or components in system 500 by connecting to leads (leads 216 of FIG. 2) disposed within a lining (e.g., lining 224 (FIG. 2)) of shoe 502. In other examples, light source 504 may be implemented to illuminate in multiple patterns (e.g., radiating light perpendicular to sole 512 (i.e., facing downward from sole 512)). In still other examples, there may be fewer or more implementations of light source 504 integrated with shoe 502.

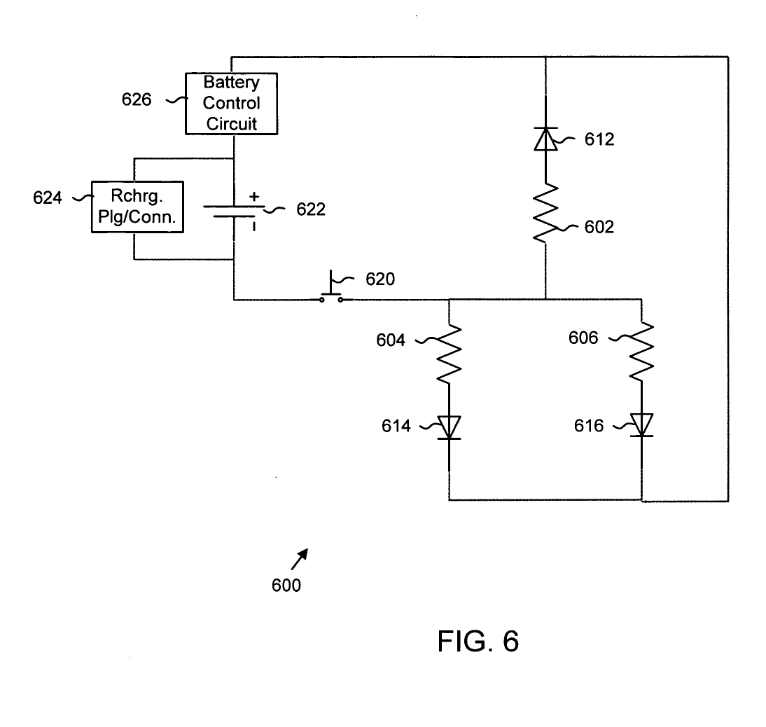

FIG. 6 is a circuit diagram illustrating an exemplary electrical power system circuit. Here, circuit 600 includes resistors 602-106, light sources 612-116, switch 620, power cell 622, recharge plug (i.e., connector) 624, and battery control circuit 626. Light sources 612-116 may be activated or deactivated by closing or opening switch 620. Resistors 602-106 may have various resistance values, depending on the respective light sources 612-116. For example, light source 612 may be a light emitting diode (LED). In some examples, light source 612 may be a red LED. In other examples, light source 612 may be a blue LED or a LED of a different color. In still other examples, light sources 612-616 may be LEDs, fluorescent, incandescent, halogen, or other light-emitting devices. Although three light sources are shown in FIG. 6, in other examples, there may be more or fewer light sources in circuit 600. In still other examples, additional accessories (e.g., high-powered flashlight, cell phone, MP3 player, and others) may receive power from power cell 622. Power cell 622 may be implemented using a single or multiple cell battery. Power cell 622 may be rechargeable. In some examples, power cell 622 may be a rechargeable battery. In other examples, Lithium Ion, Nickel-Metal-Hydride, or other fuel cell technologies may be used for power cell 622. Recharge plug 624 may be configured to recharge power cell 622 by providing a connection to a charger. In some examples, the charger may provide a DC or AC voltage to charge or recharge power cell 622. In other examples, the charger may be implemented as a single cell or multiple cell battery, as a solar charger, power inverter, or as another AC/DC charger. Battery control circuit 626 may be used to control current output from power cell 622 to ensure steady current is delivered to light sources 612-616. In contrast to using a regular battery-powered light source (not shown), in which the light may become dim or non-functional over time (e.g., during an extended jog), the steady current of circuit 600 ensures that light sources 612-616 remain steady in brightness and do not dim during use. In some examples, other circuit components may be included and circuit 600 may be implemented differently, including various components in either series or parallel configurations. In other examples, switch 620 may be coupled to a wireless transceiver (not shown) that enables remote activation and deactivation of electrical current to one, some, or all circuit elements. In the above examples, variations may be performed to enable local or remote control, using direct or indirect means (e.g., wireless RF transceivers) for sending control signals to activate or deactivate a switch (e.g., switch 620) or other elements of electrical power systems for footwear. Different circuit configurations may be implemented by modifying some or all of the circuit elements shown and described above. In other examples, circuit 600 and the above-described elements may be varied and are not limited to the functions, structures, configurations, or implementations provided.

Although the foregoing embodiments have been described in some detail for purposes of clarity of understanding, the invention is not limited to the details provided. There are many alternative ways of implementing the invention. The disclosed embodiments are illustrative and not restrictive.

What is claimed:

1. A system, comprising:
a port configured to receive an electrical current;
a power cell configured to store the electrical current;
a light source coupled to the power cell;
a switch configured to control activation of the light source by enabling the electrical current to flow from the power cell to the light source, the switch being coupled to the light source and the power cell; and
a distribution system configured to provide a path to enable the electrical current to flow within the system.

2. The system of claim 1, wherein the system is substantially weather-resistant.

3. The system of claim 1, wherein the system is disposed within a lining of a shoe.

4. The system of claim 1, wherein the power cell is configured to charge when coupled to a power source.

5. A system, comprising:
a connector configured to receive an electrical current, the connector being mounted within a lining of a shoe;
a power cell configured to store the electrical current from the connector, the power cell being disposed within the lining of the shoe;
a light source coupled to the power cell, the light source being disposed within a sole of the shoe and configured to propagate light outward from the sole;
a switch configured to control activation of the light source, the switch being coupled to the light source and disposed within the lining of the shoe; and
a distribution system configured to conduct the electrical current within the system, the distribution system being disposed within the lining of the shoe.

6. The system of claim 5, wherein the connector is disposed in a pocket formed in an upper section of the shoe.

7. The system of claim 5, wherein the connector is partially exposed from the shoe.

8. The system of claim 5, wherein the power cell is rechargeable;

9. The system of claim 5, wherein the power cell is disposed in a pocket formed in an upper section of the shoe.

10. The system of claim 5, wherein the power cell further comprises a processor configured to control a bidirectional flow of the electrical current.

11. The system of claim 5, wherein the light source is a light-emitting diode.

12. The system of claim 5, wherein the light source is integrated with a mounting surface of a cavity formed within the sole, the mounting surface being disposed substantially parallel to the sole.

13. The system of claim 5, wherein the light source is coupled to a mounting surface of a cavity within the sole, the mounting surface being disposed substantially perpendicular to the sole.

14. The system of claim 5, wherein the light source is configured to illuminate through an opening in the sole.

15. The system of claim 5, wherein the light source is configured to illuminate from an outer surface of the sole.

16. The system of claim 5, wherein the switch is configured to be remotely manipulated.

17. The system of claim 5, wherein the switch is disposed in a cavity formed in a tongue of the shoe.

18. The system of claim 5, wherein the switch protrudes from the shoe.

19. The system of claim 5, wherein the switch is sealed in a cavity within the shoe.

20. The system of claim 5, wherein the distribution system is housed in a channel formed within the lining of the shoe.

21. The system of claim 5, further comprising a communications system coupled to the system, wherein one or more elements of the communication system use electrical current from the power cell.

22. A system, comprising:
a connector configured to receive an electrical current, the connector being housed in a first cavity formed in an upper section of a lining of a shoe;
a power cell configured to store the electrical current received by the system using the connector, the power cell being housed in a second cavity formed in another upper section of the lining of the shoe, the power cell comprising a processor to control the electrical current in a bidirectional flow;
a light source coupled to the power cell, the light source being integrated with a mounting surface of a sole of the shoe;
a switch configured to control activation of the light source, the switch being coupled to the light source and disposed in a third cavity formed in a tongue associated with the shoe; and
a distribution system configured to conduct the electrical current within the system, the distribution system being housed in a channel formed within the lining of the shoe.
